(19) United States
(12) Patent Application Publication
(10) Pub. No.: US 2026/0006645 A1
(43) Pub. Date: Jan. 1, 2026

(54) EMERGENCY COMMUNICATION SYSTEM FOR WIRELESS NETWORK

(71) Applicant: Samsung Electronics Co., Ltd., Suwon-si, Gyeonggi-do (KR)

(72) Inventors: Peshal Nayak, Plano, TX (US); Boon Loong Ng, Plano, TX (US); Rubayet Shafin, Allen, TX (US); Vishnu Vardhan Ratnam, Frisco, TX (US); Yue Qi, Plano, TX (US); Bilal Sadiq, Plano, TX (US)

(21) Appl. No.: 19/231,351

(22) Filed: Jun. 6, 2025

Related U.S. Application Data
(60) Provisional application No. 63/665,898, filed on Jun. 28, 2024.
(60) Provisional application No. 63/786,599, filed on Apr. 10, 2025.
(60) Provisional application No. 63/797,482, filed on Apr. 30, 2025.

(51) Int. Cl. H04W 74/0816; H04W 4/90; H04W 74/08

(52) U.S. Cl. CPC H04W 74/0816; H04W 4/90; H04W 74/0875

(57) ABSTRACT

A non-access point (AP) device for facilitating wireless communication. The non-AP device has one or more stations (STAs) affiliated with the non-AP device and a processor coupled to the one or more STAs. The non-AP device receives, from an AP device, a frame including an enhanced distributed channel access (EDCA) parameter set that provides prioritized access to a wireless medium for emergency preparedness communication services (EPCS) traffic. The non-AP device transmits a defer signal that causes receiving devices to defer frame transmission. The non-AP device accesses the wireless medium based on the EDCA parameter set. The non-AP device transmits one or more frames including EPCS traffic over the wireless medium.

### CROSS REFERENCE TO RELATED APPLICATION(S)

This application claims benefit of U.S. Provisional Application No. 63/665,898, entitled “EMERGENCY COMMUNICATION SYSTEM FOR NEXT GENERATION WLANS,” filed on Jun. 28, 2024; U.S. Provisional Application No. 63/786,599, entitled “EMERGENCY COMMUNICATION SYSTEM FOR NEXT GENERATION WLANS,” filed on Apr. 10, 2025; and U.S. Provisional Application No. 63/797,482, entitled “EMERGENCY COMMUNICATION SYSTEM FOR NEXT GENERATION WLANS,” filed on Apr. 30, 2025, in the United States Patent and Trademark Office, all of which are hereby incorporated by reference in their entireties.

### TECHNICAL FIELD

This disclosure relates generally to a wireless communication system, and more particularly to, for example, but not limited to, emergency communication system operation in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

This disclosure may be directed to improvements to a wireless communications system, more particularly to provide a mechanism and protocol for enabling priority access to EPCS devices in EPCS operation for the next generation WLAN.

An aspect of the disclosure provides a non-access point (AP) device for facilitating wireless communication. The non-AP device comprises one or more stations (STAs) affiliated with the non-AP device and a processor coupled to the one or more STAs. The processor is configured to cause receiving, from an AP device, a frame including an enhanced distributed channel access (EDCA) parameter set that provides prioritized access to a wireless medium for emergency preparedness communication services (EPCS) traffic. The processor is further configured to cause transmitting a defer signal that causes receiving devices to defer frame transmission. The processor is further configured to cause accessing the wireless medium based on the EDCA parameter set. The processor is further configured to cause transmitting one or more frames including EPCS traffic over the wireless medium.

In an embodiment, the processor is further configured to cause transmitting, to the AP device, a request frame requesting the EDCA parameter set that provides prioritized access to the wireless medium for EPCS traffic.

In an embodiment, the EDCA parameter set includes one or more parameters that provide the EPCS traffic with a higher priority than non-EPCS traffic.

In an embodiment, the processor is further configured to cause receiving, from the AP device, a frame including an updated EDCA parameter set. The processor is further configured to cause accessing the wireless medium based on the updated EDCA parameter set.

In an embodiment, the EDCA parameter set is applied for one or more particular traffic types.

In an embodiment, the EDCA parameter set is applied for a particular STA affiliated with the non-AP device.

In an embodiment, the defer signal is transmitted at a predetermined time that is earlier than a defer signal transmitted by a device that does not transmit EPCS traffic.

In an embodiment, the defer signal is transmitted when a predetermined criteria is satisfied.

In an embodiment, the processor is further configured to cause transmitting a frame advertising a capability that supports transmitting EPCS traffic using a defer signal.

An aspect of the disclosure provides an AP device for facilitating wireless communication. The AP device comprises one or more APs affiliated with the AP device and a processor coupled to the one or more APs. The processor is configured to cause receiving, from a non-AP device, a frame requesting priority access to a wireless medium for EPCS traffic. The processor is further configured to cause transmitting, to a non-AP device, a frame including an EDCA parameter set that provides prioritized access to the wireless medium for EPCS traffic.

In an embodiment, the EDCA parameter set includes one or more parameters that provide the EPCS traffic with a higher priority than non-EPCS traffic.

In an embodiment, the processor is further configured to cause transmitting, to the non-AP device, a frame including an updated EDCA parameter set.

In an embodiment, the EDCA parameter set is applied for one or more particular traffic types.

In an embodiment, the EDCA parameter set is applied for a particular STA affiliated with the non-AP device.

In an embodiment, the processor is further configured to cause receiving, from the non-AP device, a frame advertising a capability that supports transmitting EPCS traffic using a defer signal.

In an embodiment, the processor is further configured to cause determining that a number of STAs associated with the AP device using any EDCA parameter sets providing the prioritized access for EPCS traffic is above a predetermined threshold. The processor is further configured to cause transmitting a frame indicating that the prioritized access is disabled.

An aspect of the disclosure provides a method performed by a non-AP device. The method comprises receiving, from an AP device, a frame including an EDCA parameter set that provides prioritized access to a wireless medium for EPCS traffic. The method further comprises transmitting a defer signal that causes receiving devices to defer frame transmission. The method further comprises accessing the wireless medium based on the EDCA parameter set. The method further comprises transmitting one or more frames including EPCS traffic over the wireless medium.

In an embodiment, the method further comprises transmitting, to the AP device, a request frame requesting the EDCA parameter set that provides prioritized access to the wireless medium for EPCS traffic.

In an embodiment, the EDCA parameter set includes one or more parameters that provide the EPCS traffic with a higher priority than non-EPCS traffic.

In an embodiment, the method further comprises receiving, from the AP device, a frame including an updated EDCA parameter set. The method further comprises accessing the wireless medium based on the updated EDCA parameter set.

### BRIEF DESCRIPTION OF THE DRAWINGS

FIG. 1 illustrates an example of a wireless network in accordance with an embodiment of this disclosure.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example network in accordance with an embodiment.

FIG. 5 shows an example EPCS operation in accordance with an embodiment.

FIG. 6 shows another example EPCS operation in accordance with an embodiment.

FIG. 7 shows another example EPCS operation in accordance with an embodiment.

FIG. 8 shows another example EPCS operation in accordance with an embodiment.

FIG. 9 shows another example EPCS operation in accordance with an embodiment.

FIG. 10 shows another example EPCS operation in accordance with an embodiment.

FIG. 11 shows another example EPCS operation in accordance with an embodiment.

FIG. 12 shows an example EPCS priority access enable request frame in accordance with an embodiment.

FIG. 13 shows another example EPCS operation in accordance with an embodiment.

FIG. 14 shows another example EPCS operation in accordance with an embodiment.

FIG. 15 shows another example EPCS operation in accordance with an embodiment.

FIG. 16 shows an example process for EPCS operation in accordance with an embodiment.

FIG. 17 shows another example process for EPCS operation in accordance with an embodiment.

FIG. 18 shows another example process for EPCS operation in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The present disclosure relates to a wireless communication system, and more particularly, to a Wireless Local Area Network (WLAN) technology. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac. 802.11ax etc.

Before undertaking the detailed description below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

Figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

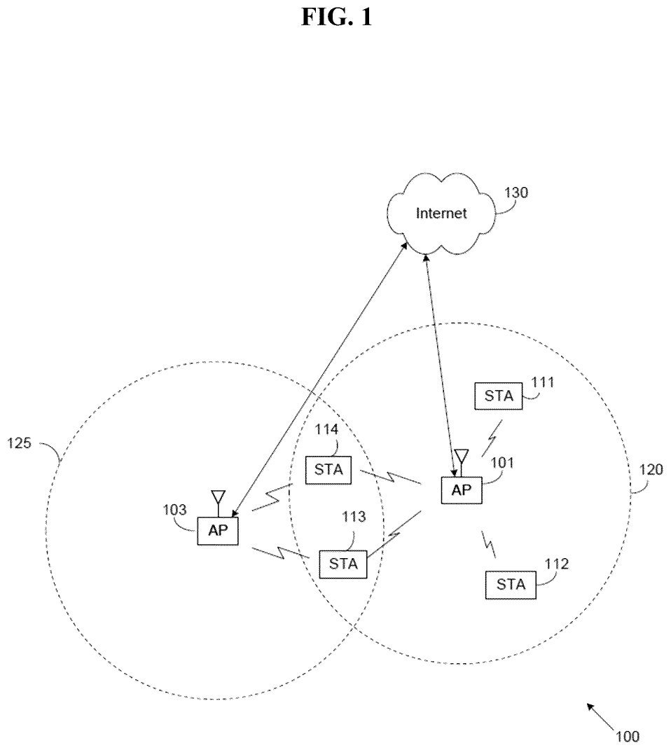

FIG. 1 shows an example wireless network 100 according to this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WiFi or other WLAN communication techniques.

Depending on the network type, other well-known terms may be used instead of “access point” or “AP,” such as “router” or “gateway.” For the sake of convenience, the term “AP” is used in this patent document to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this patent document to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for management of multiple user (MU)-MIMO and orthogonal frequency division multiple access (OFDMA) channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

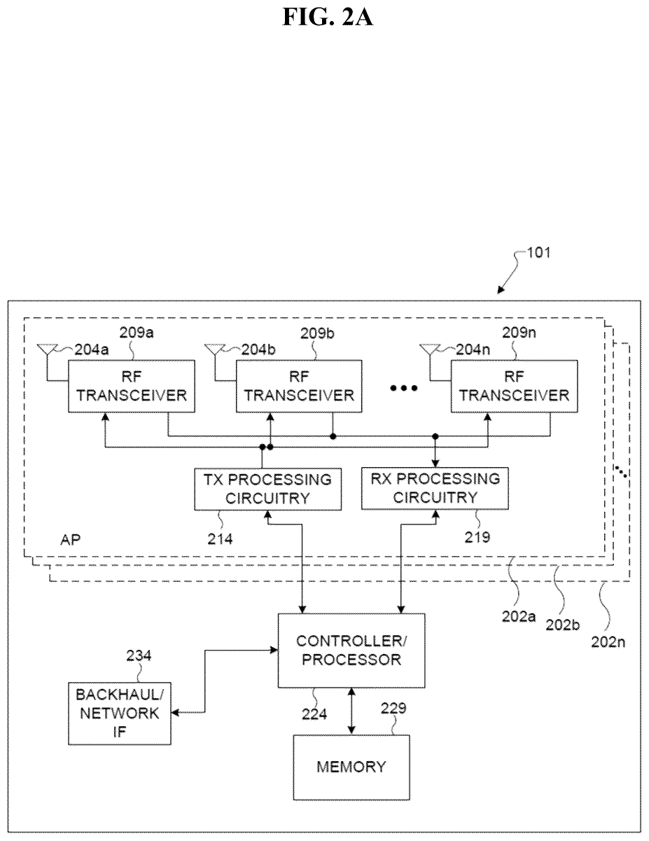

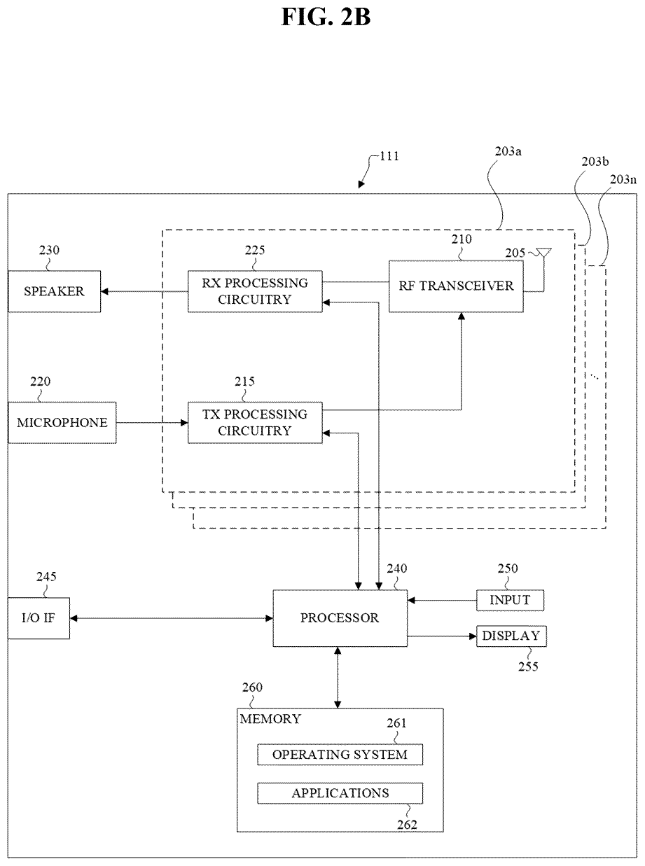

FIG. 2A shows an example AP 101 according to this disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

As shown in FIG. 2A, the AP 101 includes multiple antennas 204a-204n, multiple RF transceivers 209a-209n, transmit (TX) processing circuitry 214, and receive (RX) processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions.

For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A shows one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

FIG. 2B shows an example STA 111 according to this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

As shown in FIG. 2B, the STA 111 includes antenna(s) 205, a radio frequency (RF) transceiver 210, TX processing circuitry 215, a microphone 220, and receive (RX) processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to provide management of channel sounding procedures in WLANs. In some embodiments, the controller/processor 240 includes at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B shows the STA 111 configured as a mobile telephone or smartphone, STAs could be configured to operate as other types of mobile or stationary devices.

As shown in FIG. 2B, in some embodiments, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

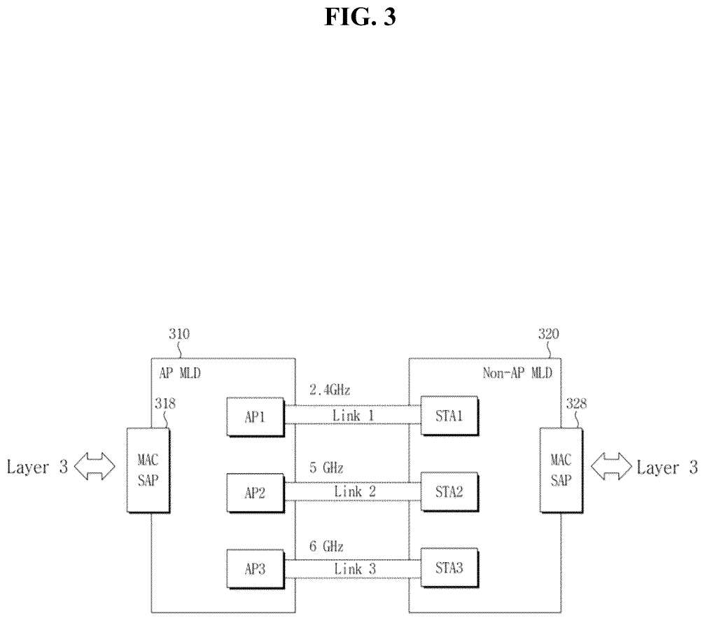

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D6.0, “Wireless LAN Medium Access Control (MAC) and Physical Layer (PHY) Specifications.”

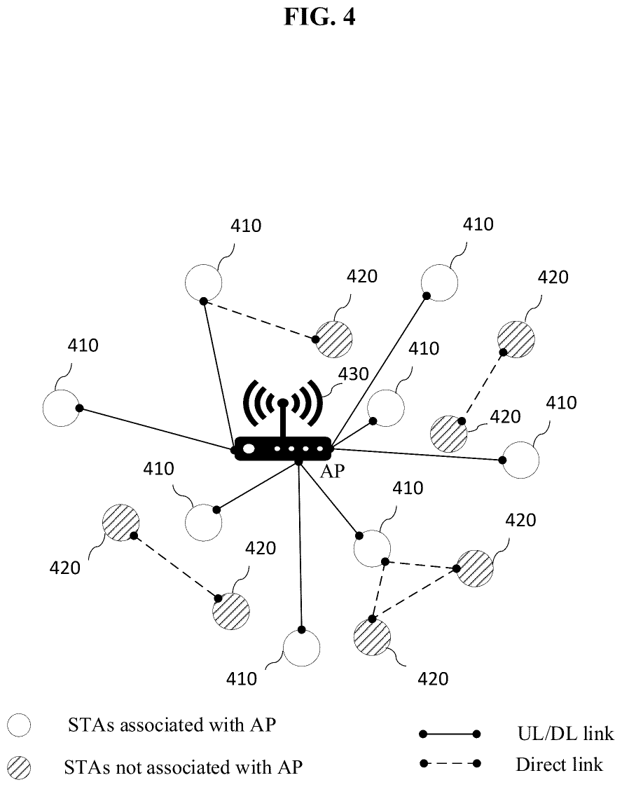

FIG. 4 shows an example network in accordance with an embodiment. The network depicted in FIG. 4 is for explanatory and illustration purposes. FIG. 4 does not limit the scope of this disclosure to any particular implementation.

In FIG. 4, a plurality of STAs 410 may be non-AP STAs associated with AP 430, and a plurality of STAs 420 may be non-AP STAs which are not associated with AP 430. Additionally, solid lines between STAs represent uplink or downlink with AP 430, while the dashed lines between STAs represent a direct link between STAs.

Emergency telecommunication services have been implemented in a number of countries with the objective of providing prioritized access in the event of disasters or emergencies. Examples of such telecommunication services in the United States includes government emergency telecommunication service (GETS), wireless priority service (WPS), next generation network priority services (NGN priority services) and telecommunications service priority (TSP). Such services have also been implemented in other countries. Examples of such services outside of the United States include blue light mobile service in Belgium, mobile telecommunications privileged access scheme in Great Britain and disaster priority telephone in Japan. Typically, such services are subscription based, operator controlled, enabled through global standards and are offered over commercial network infrastructure.

In recent times there has been a growing need for such services over Wi-Fi networks. In IEEE 802.11be, Emergency Preparedness Communication Services (EPCS) has been introduced with the goal of providing prioritized access to certain authorized users. As a part of this service, a user that has associated with an AP can be authorized by the AP to take advantage of EPCS service. Once authorized, the user can use an enhanced distributed channel access (EDCA) parameter set with values for parameters such as CW (contention window) min [AC (access category)], CWmax [AC] and AIFSN (arbitration interframe space number) [AC], which are different from those for other STAs associated with the same AP. With this EDCA parameter set, the non-AP MLD that is authorized by the AP, benefits from prioritized access as it can capture the channel faster compared to other users in the network. After EPCS is disabled, the non-AP MLD can update its EDCA parameter set to match that of other non-EPCS users in the network.

Currently, when a device is authorized for EPCS, the device obtains an EDCA parameter set. However, in next generation WLAN, such an EDCA parameter set may not be sufficient to provide channel access as many features which support low latency applications may conflict with it. For example, an ultra-high reliability (UHR) device that supports IEEE 802.11bn standard and is used for low latency applications can use a prioritized EDCA (P-EDCA) parameter set to capture the channel at an earlier time compared to a legacy device. As a result, a UHR device can capture the channel at an earlier time compared to an EPCS device employing legacy EPCS channel access mechanism. For this reason, procedures enabling priority access to UHR EPCS devices in next generation WLANs are preferred.

In an embodiment, a device can be authorized for transmission of a special signal (SS) frame, which may be referred to as a defer signal (DS) frame, when the device is authorized for EPCS. The transmission of the SS can cause the other devices which did not transmit the SS frame to state wherein they do not participate in the channel access/contention for a period of time (hereby referred to as a non-access state). Examples of such states include an extended interframe space (EIFS) state and a network allocation vector (NAV) setting.

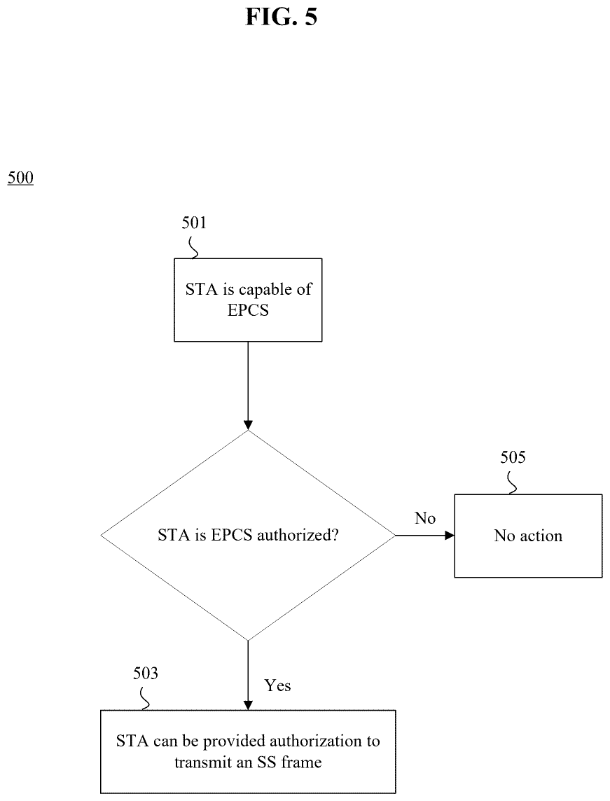

FIG. 5 shows an example EPCS operation in accordance with an embodiment. The example depicted in FIG. 5 is for explanatory and illustration purposes. FIG. 5 does not limit the scope of this disclosure to any particular implementation.

Referring to FIG. 5, the processor 500 begins at operation 501. In operation 501, STA is capable of EPCS. Operation 501 is followed by operation 503 if STA is EPCS authorized. Operation 501 is followed by operation 505 if STA is not EPCS authorized.

In operation 503, STA can be provided authorization to transmit an SS frame. The authorization can be provided by an AP device capable of supporting EPCS operation.

In operation 505, STA takes no action regarding EPCS including not receiving authorization to transmit an SS frame.

In FIG. 5, an STA or an AP can announce a duration for a device that received an SS frame to transition into non-access state. The duration can be announced via transmission of the SS frame. The duration may, instead of being announced, be a default duration or a pre-determined duration. The duration can be determined in a number of ways when announced via transmission of the SS frame such as by a field in the SS frame. The field may specify the time or the modulation of the SS frame.

In an embodiment, an EPCS authorized device can transmit an SS frame at a predetermined time boundary, such as a distributed coordination function (DCF) interframe space (DIFS) boundary following data transmission, when the EPCS authorized device is authorized to transmit the SS frame.

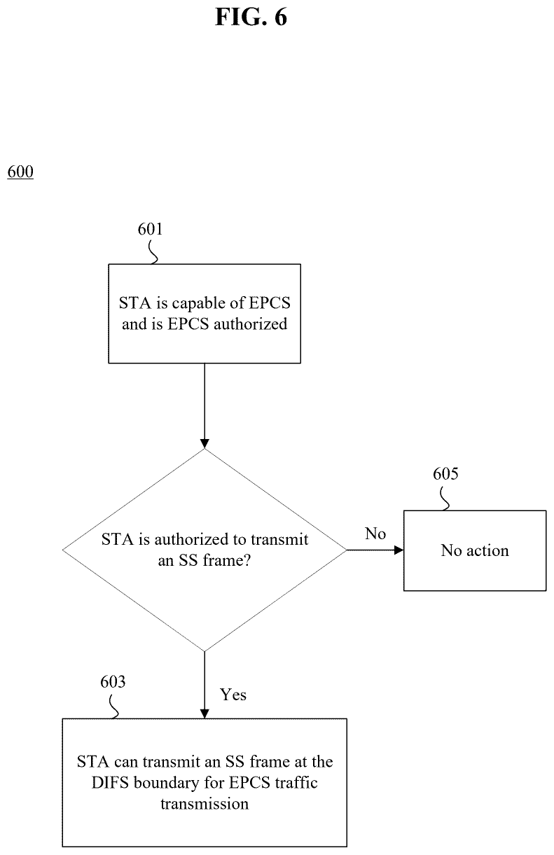

FIG. 6 shows another example EPCS operation in accordance with an embodiment.

The example depicted in FIG. 6 is for explanatory and illustration purposes. FIG. 6 does not limit the scope of this disclosure to any particular implementation.

Referring to FIG. 6, the processor 600 begins at operation 601. In operation 601, STA is capable of EPCS and is EPCS authorized. Operation 601 is followed by operation 603 if STA is authorized to transmit an SS frame. Operation 601 is followed by operation 605 if STA is not authorized to transmit an SS frame.

In operation 603, STA can transmit an SS frame at the DIFS boundary for EPCS traffic transmission.

In operation 605, STA takes no action regarding transmission of an SS frame.

In an embodiment, a device can switch to a non-access state after receiving an SS frame. While in the non-access state, the device can avoid participating in channel access/contention.

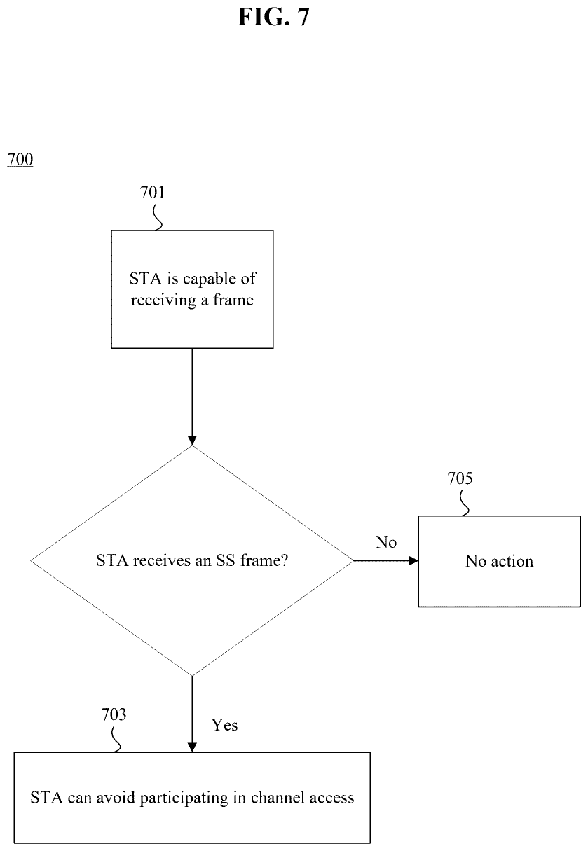

FIG. 7 shows another example EPCS operation in accordance with an embodiment.

The example depicted in FIG. 7 is for explanatory and illustration purposes. FIG. 7 does not limit the scope of this disclosure to any particular implementation.

Referring to FIG. 7, the processor 700 begins at operation 701. In operation 701, STA is capable of receiving a frame. Operation 701 is followed by operation 703 if STA receives an SS frame. Operation 701 is followed by operation 705 if STA does not receive an SS frame.

In operation 703, STA can avoid participating in channel access.

In operation 705, STA takes no action regarding avoiding participation in channel access.

In an embodiment, an EPCS device can participate in channel access following the transmission of an SS frame by another EPCS device, if the EPCS device has also transmitted an SS frame.

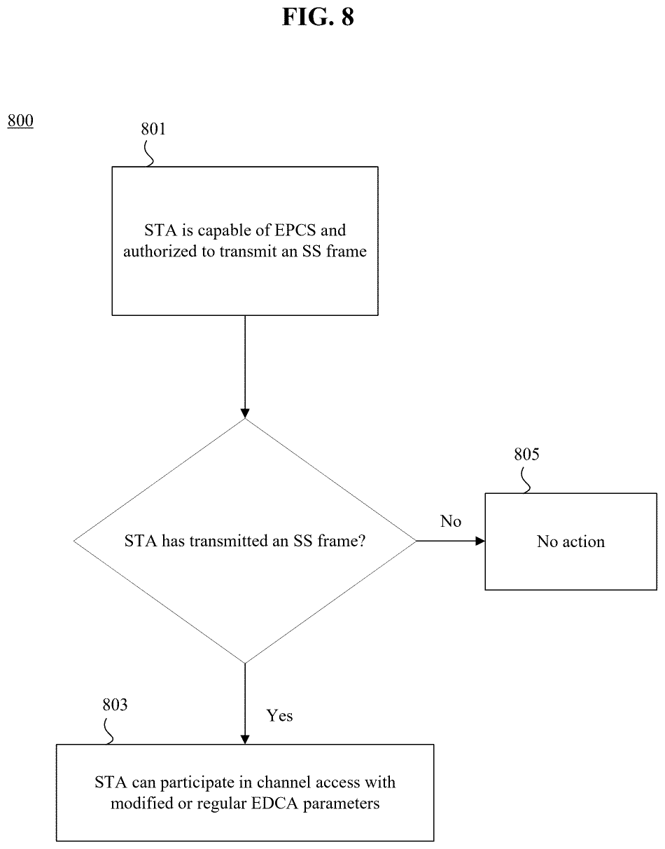

FIG. 8 shows another example EPCS operation in accordance with an embodiment.

The example depicted in FIG. 8 is for explanatory and illustration purposes. FIG. 8 does not limit the scope of this disclosure to any particular implementation.

Referring to FIG. 8, the processor 800 begins at operation 801. In operation 801, STA is capable of EPCS and authorized to transmit an SS frame. Operation 801 is followed by operation 803 if STA has transmitted an SS frame. Operation 801 is followed by operation 805 if STA has not transmitted an SS frame.

In operation 803, STA can participate in channel access with modified or regular EDCA parameters.

In operation 805, STA takes no action regarding participating in channel access with modified or regular EDCA parameters.

In an embodiment, an EPCS device can perform channel access/contention by using a modified EDCA parameter set. The modified EDCA parameter set can be provided to the EPCS device during authorization of EPCS.

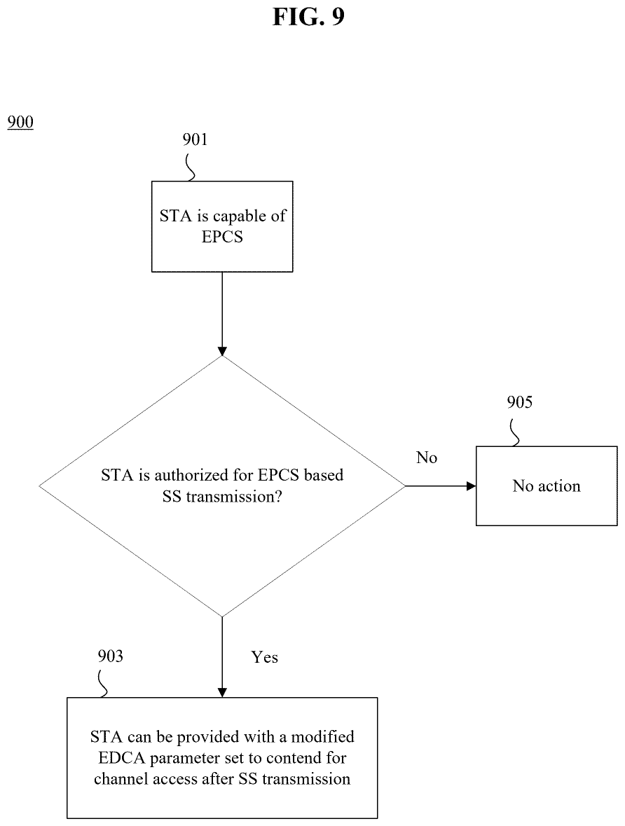

FIG. 9 shows another example EPCS operation in accordance with an embodiment.

The example depicted in FIG. 9 is for explanatory and illustration purposes. FIG. 9 does not limit the scope of this disclosure to any particular implementation.

Referring to FIG. 9, the processor 900 begins at operation 901. In operation 901, STA is capable of EPCS. Operation 901 is followed by operation 903 if STA is authorized for EPCS based SS transmission. Operation 901 is followed by operation 905 if STA is not authorized for EPCS based SS transmission.

In operation 903, STA can receive a modified EDCA parameter set to contend for channel access after SS transmission.

In operation 905, STA takes no action regarding receiving a modified EDCA parameter set.

In an embodiment, an SS frame can be a MAC frame, a clear to send (CTS)-to-self, or a PHY header or a portion thereof.

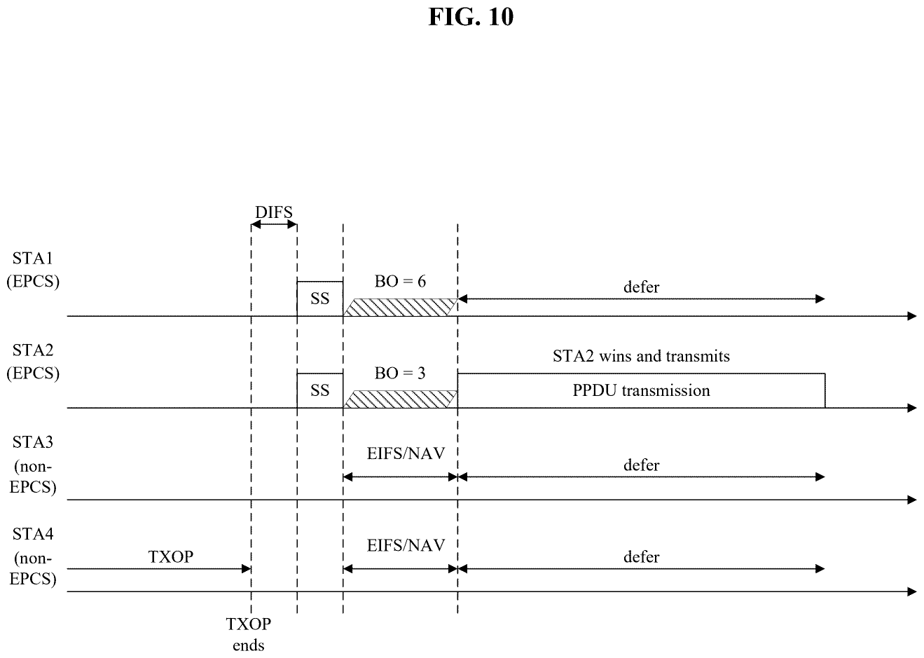

FIG. 10 shows another example EPCS operation in accordance with an embodiment.

The example depicted in FIG. 10 is for explanatory and illustration purposes. FIG. 10 does not limit the scope of this disclosure to any particular implementation.

Referring to FIG. 10, STA1, STA2, STA3 and STA4 intend to participate in channel contention. The STA1 and the STA2 are authorized for EPCS. The STA3 and the STA4 are not authorized for EPCS. The STA4 has previously obtained a transmission opportunity (TXOP) on the channel and the TXOP ends. Subsequently, after a DIFS interval, the STA1 transmits an SS frame. The STA2 also transmits an SS frame after the DIFS interval. The STA3 receives at least one SS frame if a first condition or a second condition is satisfied. The first condition can be satisfied if the STA3 was waiting for the expiration of an EIFS interval when the SS frame was transmitted. Additionally, the first condition requires that the EIFS interval expires later than the STA3's NAV. The second condition can be satisfied if the STA3 was waiting for the expiration of the STA3's NAV when the SS frame was transmitted. Additionally, the second condition requires that the STA3's NAV expires later than the EIFS interval. The STA4 receives at least one SS frame if a first condition or a second condition is satisfied. The first condition can be satisfied if the STA4 was waiting for the expiration of an EIFS interval when the SS frame was transmitted. Additionally, the first condition requires that the EIFS interval expires later than the STA4's NAV. The second condition can be satisfied if the STA4 was waiting for the expiration of the STA4's NAV when the SS frame was transmitted. Additionally, the second condition requires that the STA4's NAV expires later than the EIFS interval. Following the transmission of the SS frames, channel contention begins. In this example, the STA1 invokes a random backoff (BO) counter of 6, while the STA2 invokes a random BO counter of 3. The STA3 and the STA4 do not contend for the channel. Subsequently, the STA2 wins contention for the channel and performs a PHY protocol data unit (PPDU) transmission. The STA1, the STA3 and the STA4 defer access of the channel during the STA2's PPDU transmission.

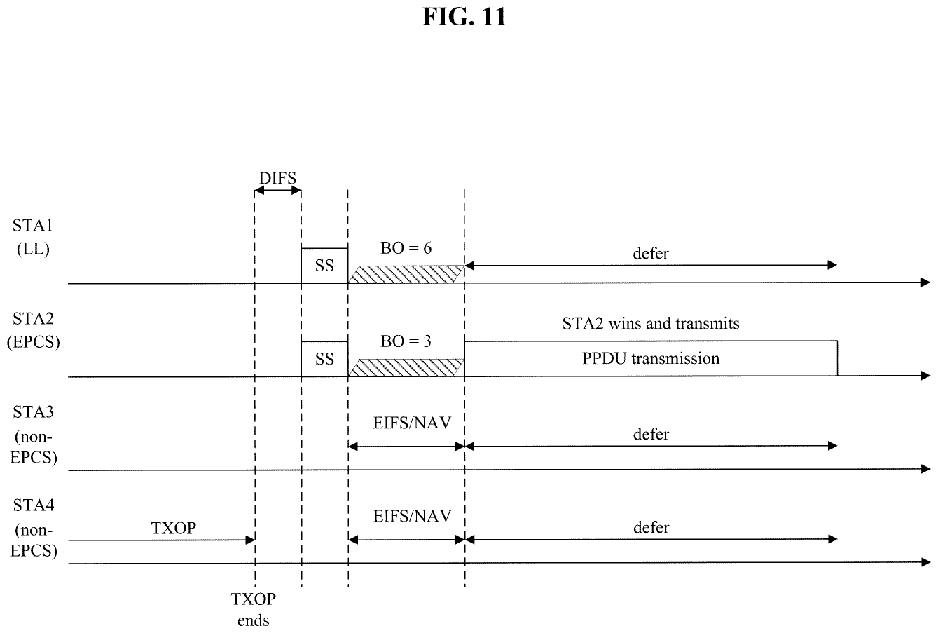

FIG. 11 shows another example EPCS operation in accordance with an embodiment. The example depicted in FIG. 11 is for explanatory and illustration purposes. FIG. 11 does not limit the scope of this disclosure to any particular implementation.

Referring to FIG. 11, STA1, STA2, STA3 and STA4 intend to participate in channel contention. The STA1 is a low latency (LL) STA. The STA2 is authorized for EPCS. The STA1, the STA3 and the STA4 are not authorized for EPCS. The STA4 has previously obtained a TXOP on the channel and the TXOP ends. Subsequently, after a DIFS interval, the STA1 transmits an SS frame. The STA2 also transmits an SS frame after the DIFS interval. The STA3 receives at least one SS frame if a first condition or a second condition is satisfied. The first condition can be satisfied if the STA3 was waiting for the expiration of an EIFS interval when the SS frame was transmitted. Additionally, the first condition requires that the EIFS interval expires later than the STA3's NAV. The second condition can be satisfied if the STA3 was waiting for the expiration of the STA3's NAV when the SS frame was transmitted. Additionally, the second condition requires that the STA3's NAV expires later than the EIFS interval. The STA4 receives at least one SS frame if a first condition or a second condition is satisfied. The first condition can be satisfied if the STA4 was waiting for the expiration of an EIFS interval when the SS frame was transmitted. Additionally, the first condition requires that the EIFS interval expires later than the STA4's NAV. The second condition can be satisfied if the STA4 was waiting for the expiration of the STA4's NAV when the SS frame was transmitted. Additionally, the second condition requires that the STA4's NAV expires later than the EIFS interval. Following the transmission of the SS frames, channel contention begins. In this example, the STA1 invokes a random BO counter of 6, while the STA2 invokes a random BO counter of 3. The STA3 and the STA4 do not contend for the channel. Subsequently, the STA2 wins contention for the channel and performs a PPDU transmission. The STA1, the STA3 and the STA4 defer access of the channel during the STA2's PPDU transmission.

In an embodiment, an AP that is capable of supporting SS based EPCS can advertise this capability in one or more frames that the AP transmits. These frames may be management frames, such as beacons.

In an embodiment, an STA that is capable of supporting SS based EPCS can advertise this capability in one or more frames that the STA transmits.

In an embodiment, the operations and procedures discussed above can be applied for use in multi-link operation and is not limited to single link operation.

In an embodiment, the SS frame can be referred to by any other name such as a DS frame or a DS-CTS frame.

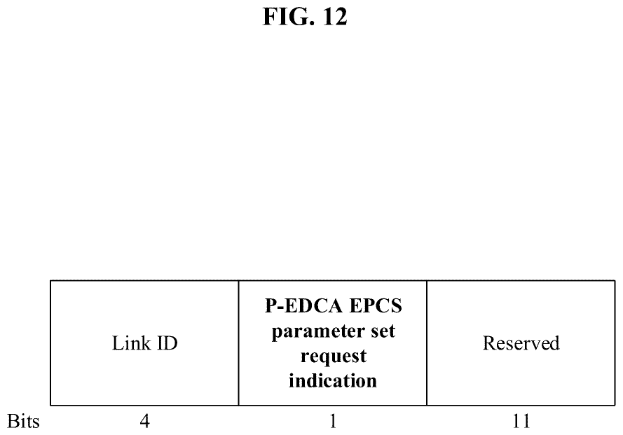

In an embodiment, a non-AP MLD with EPCS enabled can transmit an EPCS priority access enable request frame to an AP MLD. The EPCS priority access enable request frame can indicate to the AP MLD that the non-AP MLD can be provided with an EPCS P-EDCA parameter set for the channel contention following an SS frame transmission. For instance, the indication can be made in a modified STA control field of the per-STA profile subelement carried in the priority access multi-link element in the EPCS priority access enable request frame as shown in FIG. 12. A reserved bit in legacy signaling can be used for this purpose.

FIG. 12 shows an example EPCS priority access enable request frame in accordance with an embodiment. The frame depicted in FIG. 12 is for explanatory and illustration purposes. FIG. 12 does not limit the scope of this disclosure to any particular implementation.

Referring to FIG. 12, the EPCS priority access enable request frame 1200 includes a Link ID (identifier) field, a P-EDCA EPCS parameter set request indication field, and Reserved bits. The Link ID field indicates a value that uniquely identifies the link that an AP affiliated with an AP MLD is operating on. The P-EDCA EPCS parameter set request indication field indicates that the non-AP MLD can be provided with a P-EDCA EPCS parameter set.

In an embodiment, the Link ID field may be immediately followed by the P-EDCA EPCS parameter set request indication field.

In an embodiment, an explicit request for a EPCS P-EDCA parameter set may not be necessary if a non-AP MLD with EPCS enabled is a UHR non-AP MLD. An AP MLD can provide the EPCS P-EDCA parameter set to the non-AP MLD if the AP MLD receives an EPCS priority access enable request frame from the non-AP MLD that is UHR non-AP MLD.

In an embodiment, an EPCS P-EDCA parameter set can be designed so that a STA affiliated with a non-AP MLD with EPCS in enabled state can obtain channel access during the contention duration following transmission of an SS frame. The EPCS P-EDCA parameter set may allow the STA to obtain the channel access earlier with a high probability compared to an STA affiliated with a non-AP MLD with EPCS in torn down state or a non-AP MLD that is not capable of EPCS. The EPCS P-EDCA parameter set can include at least one or more information items as shown in Table 1.

TABLE 1

| Information Item | Description |
|---|---|
| P-EDCA CWmin | A CWmin value that can be used by the STA affiliated with EPCS non- |
| | AP MLD. This value can be different from that provided by the AP MLD |
| | to a non-AP MLD with EPCS in torn down state or one that is not capable |
| | of EPCS. |
| P-EDCA CWmax | A CWmax value that can be used by the STA affiliated with the EPCS |
| | non-AP MLD. This value can be different from that provided by the AP |
| | MLD to a non-AP MLD with EPCS in torn down state or one that is not |
| | capable of EPCS. |
| P-EDCA AIFSN | A P-EDCA AIFSN value that can be used by the STA affiliated with the |
| | EPCS non-AP MLD. This value can be different (e.g., AIFSN = 1) from |
| | that provided by the AP MLD to a non-AP MLD with EPCS in torn down |
| | state or one that is not capable of EPCS. |
| P-EDCA contention | A P-EDCA contention duration/maximum contention duration that can |
| duration/maximum | be used by the STA affiliated with the EPCS non-AP MLD. |
| contention duration | |

In an embodiment, an EPCS P-EDCA parameter set element can be included in the EPCS priority access enable response frame. The EPCS P-EDCA parameter set element can also be included in the EPCS priority access enable request frame when the AP MLD transmits an unsolicited EPCS priority access enable request frame.

In an embodiment, an EPCS parameter set element can be carried in an EPCS priority access multi-link element. For example, the EPCS parameter set element can be carried in an STA profile subfield of a per-STA profile subelement.

In an embodiment, an EPCS P-EDCA parameter set element can be provided during the setup of EPCS between an AP MLD and a non-AP MLD.

In an embodiment, an EPCS P-EDCA parameter set element can be updated by the AP MLD in an unsolicited update frame such as an unsolicited EPCS priority access enable response frame.

In an embodiment, an AP MLD can use an unsolicited EPCS priority access enable response frame to update an EPCS P-EDCA parameter set for an STA affiliated with a non-AP MLD with EPCS in enabled state.

In an embodiment, an AP MLD can transmit an unsolicited enable response frame to a non AP-MLD carrying an EPCS P-EDCA parameter set element if P-EDCA was turned off at the time of EPCS setup of the non-AP MLD but was activated at a later stage.

In an embodiment, an EPCS P-EDCA parameter set can be used for all traffic of a non-AP MLD with EPCS in enabled state. The AP MLD can provide the EPCS P-EDCA parameter set to each STA affiliated with the non-AP MLD.

In an embodiment, an EPCS P-EDCA parameter set can be used for only selected traffic of a non-AP MLD such as AC_VO (access category voice).

In an embodiment, an AP MLD can provide EPCS P-EDCA parameter set(s) for one or more traffic types. These one or more traffic types include traffic types based on AC, TID (traffic identifier) or SCSID (stream classification service identifier).

In an embodiment, an STA affiliated with a non-AP MLD with EPCS in enabled state can transmit an SS frame at AIFSN, such as where AIFSN=1, that results in an earlier SS frame transmission compared to an STA affiliated with a non-AP MLD with EPCS in disabled or torn down state or a non-AP MLD not capable of EPCS.

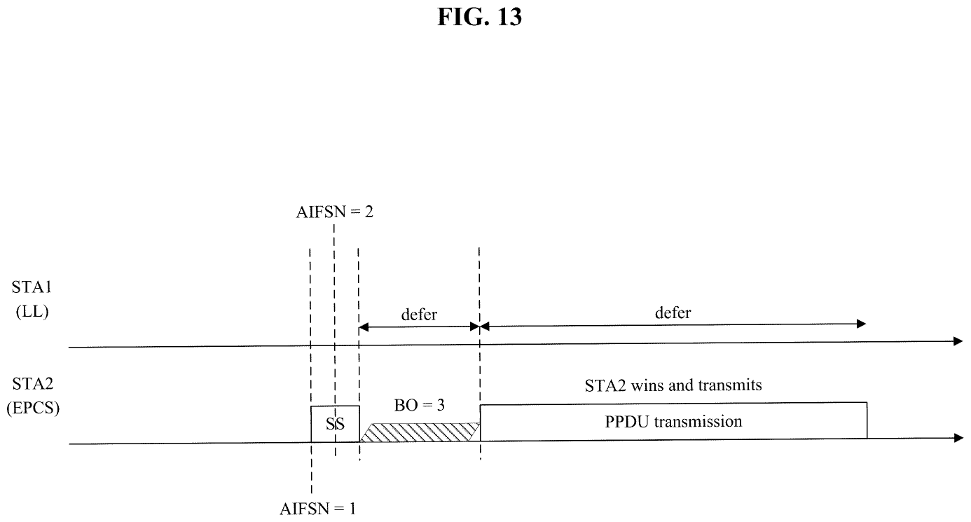

FIG. 13 shows another example EPCS operation in accordance with an embodiment. The example depicted in FIG. 13 is for explanatory and illustration purposes. FIG. 13 does not limit the scope of this disclosure to any particular implementation.

Referring to FIG. 13, an STA1 and an STA2 are interested in participating in channel contention. The STA1 is an LL STA. The STA2 is authorized for EPCS. The STA1 is not authorized for EPCS. The STA2 transmits an SS frame at AIFSN=1, or at a slot boundary of AIFSN=2. The STA2 contends for the channel with a BO of 3. The STA1 does not contend for the channel, deferring during channel contention. Subsequently, the STA2 wins contention for the channel and performs a PPDU transmission. The STA1 defers access of the channel during the STA2's PPDU transmission.

In an embodiment, an STA affiliated with a non-AP MLD with EPCS in enabled state can transmit an SS frame (or a DS frame) at a first slot boundary (e.g., AIFSN=2)+CW number of slots where the CW can be selected uniformly in (0, CW_DS_EPCS). An STA affiliated with a non-AP MLD with EPCS in disabled or torn down state or a non-AP MLD which is not capable of EPCS can transmit an SS frame at a second slot boundary (e.g., AIFSN=2)+CW number of slots where the CW can be selected uniformly in (0, CW_DS). The (0, CW_DS_EPCS) is a set chosen to be shorter than (0, CW_DS) where CW_DS_EPCS is a smaller value than CW_DS such that the STA affiliated with a non-AP MLD with EPCS in enabled state has a higher probability of capturing the channel earlier than the STA affiliated with a non-AP MLD with EPCS in disabled or torn down state or a non-AP MLD which is not capable of EPCS. The value of CW_DS_EPCS can be a predetermined fixed value or can be provided by the AP MLD along with the P-EDCA parameter set.

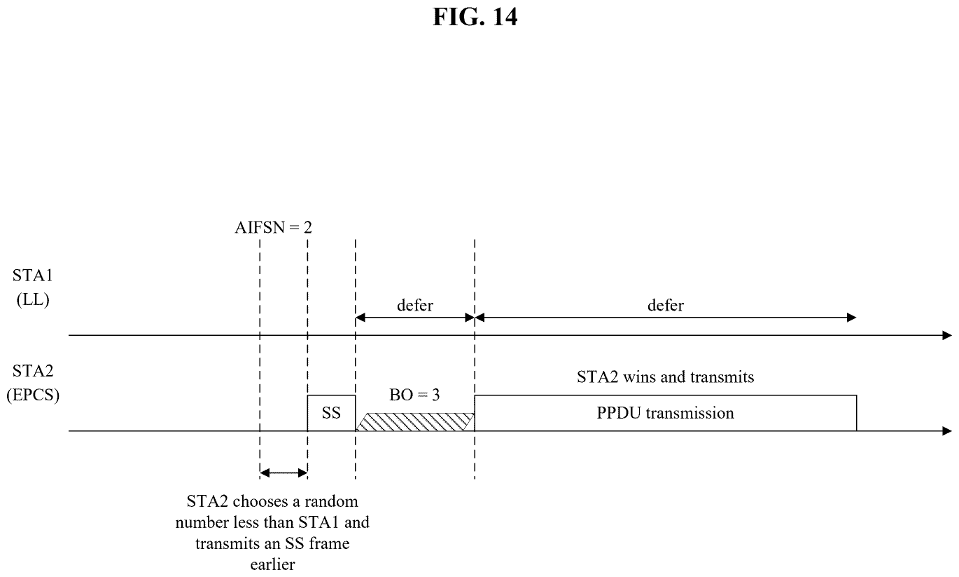

FIG. 14 shows another example EPCS operation in accordance with an embodiment. The example depicted in FIG. 14 is for explanatory and illustration purposes. FIG. 14 does not limit the scope of this disclosure to any particular implementation.

Referring to FIG. 14, STA1 and STA2 intend to participate in channel contention. In this example, the STA1 is an LL STA and the STA2 is an EPCS STA, which is authorized for EPCS. The STA1 is not authorized for EPCS. The STA2 transmits an SS frame at a slot boundary of AIFSN=2 plus a number, chosen randomly by the STA2, which is less than the slot boundary chosen by the STA1. The STA2 invokes a random BO counter of 3. The STA1 does not contend for the channel, deferring during channel contention. Subsequently, the STA2 wins contention for the channel and performs a PPDU transmission. The STA1 defers access to the channel during the STA2's PPDU transmission.

In an embodiment, a non-AP MLD can switch from an EPCS P-EDCA parameter set to a normal P-EDCA parameter set when the non-AP MLD's EPCS state is torn down. The normal P-EDCA parameter set is the P-EDCA parameter set advertised by an AP MLD, such as in a beacon frame and a probe response frame.

In an embodiment, a non-AP MLD can switch from a normal P-EDCA parameter set to an EPCS P-EDCA parameter set provided by an AP MLD when the non-AP MLD's EPCS state goes from torn down to enable.

In an embodiment, a P-EDCA parameter set can be carried in a P-EDCA parameter set element.

In an embodiment, an EPCS P-EDCA parameter set can be the same as the normal P-EDCA parameter set.

In an embodiment, an AP can disable P-EDCA in a basic service set (BSS) when at least one STA affiliated with a non-AP MLD with EPCS in the enabled state exists on the AP's link.

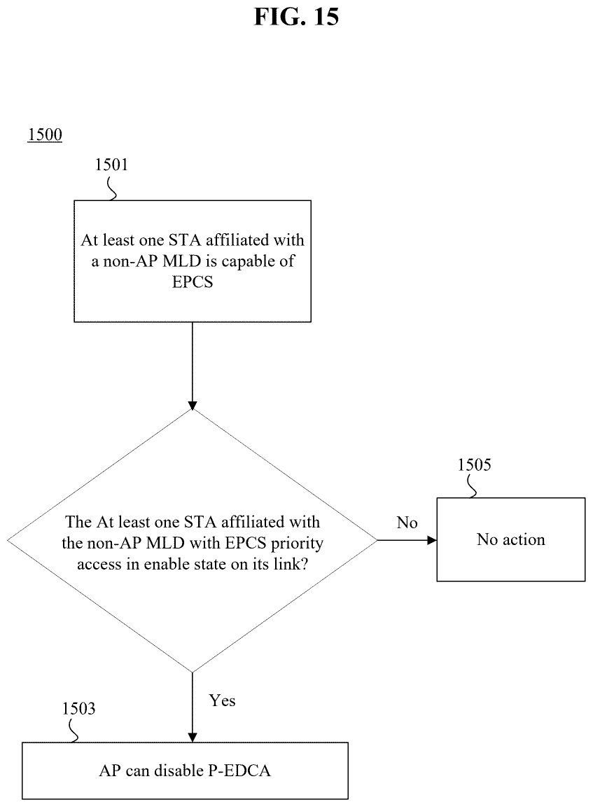

FIG. 15 shows another example EPCS operation in accordance with an embodiment. The example depicted in FIG. 15 is for explanatory and illustration purposes. FIG. 15 does not limit the scope of this disclosure to any particular implementation.

Referring to FIG. 15, an AP is capable of supporting EPCS. The AP checks whether at least one STA affiliated with a non-AP MLD with EPCS in enable state exists on the AP's link. If at least one STA affiliated with the non-AP MLD with EPCS in enable state exists, then the AP is capable of disabling P-EDCA. If no STA affiliated with the non-AP MLD with EPCS in enable state exists, then the AP takes no action.

In an embodiment, an AP can disable P-EDCA in the BSS when the number of STAs affiliated with non-AP MLDs with EPCS in the enabled state on the AP's link is above a predetermined threshold. The predetermined threshold can be a number at which the AP MLD can no longer guarantee priority access to the STAs affiliated with the non-AP MLDs with EPCS in the enabled state on the AP's link.

In an embodiment, an AP can advertise a predetermined threshold in management frames that the AP transmits, such as beacons, probe response, (re) association responses. The AP can also advertise the number of STAs affiliated with non-AP MLDs with EPCS in the enabled state on the AP's link. Advertising the predetermined threshold or the number of STAs affiliated with the non-AP MLDs can enable non-AP MLDs to know the likelihood of the AP MLD disabling EPCS on a link by looking at the difference between the number of STAs affiliated with non-AP MLDs with EPCS in the enabled state and the threshold value.

In an embodiment, an AP can only disable EPCS for STAs affiliated with non-AP MLDs with EPCS in torn down state. In an embodiment, an AP can disable EPCS for all the STAs on the link.

In an embodiment, an AP can re-enable P-EDCA on the link when at least one of the above conditions associated with the AP disabling EPCS is no longer true.

In an embodiment, an AP can perform disablement of EPCS by setting a P-EDCA support field in a UHR MAC capabilities information field to a value of 0. The AP can perform enablement of EPCS by setting the P-EDCA support field in the UHR MAC capabilities information field to a value of 1.

In an embodiment, an AP can adjust parameters associated with P-EDCA operation when at least one STA affiliated with a non-AP MLD with the EPCS in the enabled state exists on the AP's link. The P-EDCA parameters adjusted can be at least one or more of the items shown in Table 2. These are examples and the list may not be exhaustive.

TABLE 2

| Information Items | Description |
|---|---|
| CWmin | CWmin value associated with P-EDCA operation. |
| CWmax | CWmax value associated with P-EDCA operation. |
| AIFSN | AIFSN value associated with P-EDCA operation. |
| Contention Duration | Contention duration or max value of contention |
| | duration associated with P-EDCA operation. |
| Thresholds for | Examples of parameters can be a retransmission |
| parameters | counter (e.g., QSRC counter) or channel access |
| triggering P-EDCA/ | delays, time to expiration. |
| transmission of SS | |
| frame | |

In an embodiment, an AP can advertise modified values of the parameters listed above in multiple beacon frames before disabling P-EDCA. The AP's advertising of the modification of parameters may help ensure that all non-AP MLDs are informed about the disablement of the EPCS.

In an embodiment, an AP can disable P-EDCA right away after the condition is met and the AP can advertise the modified values of the parameters list above in multiple beacon frames after disabling the P-EDCA.

In an embodiment, an AP can modify P-EDCA parameters when the number of STAs affiliated with non-AP MLDs with EPCS in the enabled state exceeds a predetermined threshold.

In an embodiment, an AP can modify P-EDCA parameters when STAs affiliated with non-AP MLDs with EPCS in the enabled state are not able to maintain their priority access.

In an embodiment, an AP can modify P-EDCA parameters so that STAs affiliated with non-AP MLDs with EPCS in the enabled state can maintain their priority access.

In an embodiment, an AP MLD can perform an unsolicited operation parameter update for non-AP MLDs with EPCS in the enabled state when P-EDCA is enabled in the network or being used in the network. The unsolicited operation parameter update can be done to ensure that the STAs affiliated with the non-AP MLDs with EPCS in the enabled state continue to maintain priority access.

In an embodiment, an AP can provide parameters, which are to some degree aggressive or more aggressive if already aggressive, to non-AP MLDs with EPCS in the enabled state when P-EDCA is enabled in the network or when P-EDCA is being used in the network or when P-EDCA operation affects the priority access provided by previously provided parameters.

In an embodiment, the operations and procedures discussed above can be applied for use in single link operation and is not limited to multi-link operation.

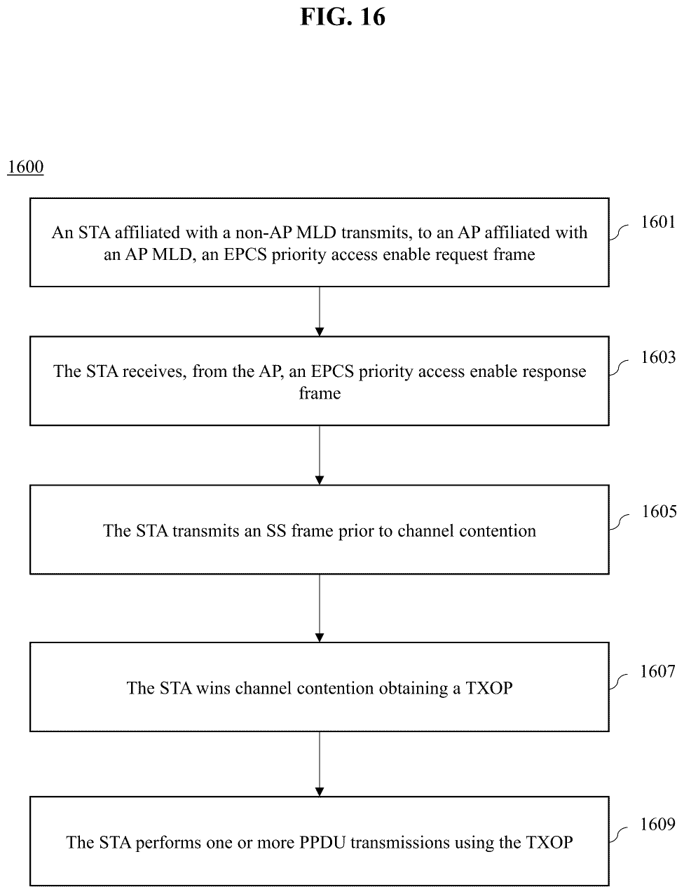

FIG. 16 shows an example process for an EPCS operation in accordance with an embodiment. The process depicted in FIG. 16 is for explanatory and illustration purposes. FIG. 16 does not limit the scope of this disclosure to any particular implementation.

Referring to FIG. 16, the processor 1600 begins at operation 1601. In operation 1601, an STA affiliated with a non-AP MLD transmits, to an AP affiliated with an AP MLD, an EPCS priority access enable request frame requesting that EPCS be enabled for the STA.

In operation 1603, the STA receives, from the AP, an EPCS priority access enable response frame accepting the request that EPCS be enabled for the STA.

In operation 1605, the STA transmits an SS frame prior to an upcoming channel contention. The SS frame may be a DS frame. The STA may transmit the SS frame at AIFSN=1 or a number less than other STAs that participate in the channel contention.

In operation 1607, the STA wins channel contention obtaining a TXOP.

In operation 1609, the STA performs one or more PPDU transmissions using the TXOP.

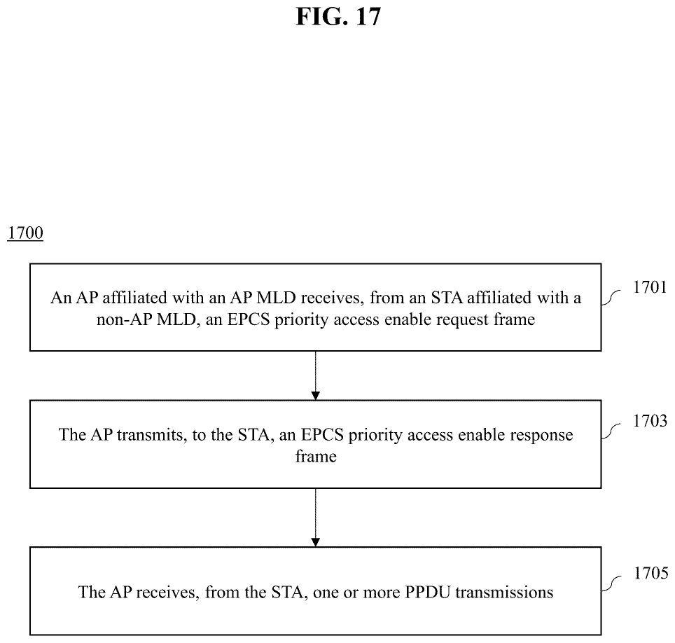

FIG. 17 shows another example process for an EPCS operation in accordance with an embodiment. The process depicted in FIG. 17 is for explanatory and illustration purposes. FIG. 17 does not limit the scope of this disclosure to any particular implementation.

Referring to FIG. 17, the processor 1700 begins at operation 1701. In operation 1701, an AP affiliated with an AP MLD receives, from an STA affiliated with a non-AP MLD, an EPCS priority access enable request frame requesting that EPCS be enabled for the STA.

In operation 1703, the AP transmits, to the AP, an EPCS priority access enable response frame accepting the request that EPCS be enabled for the STA.

In operation 1705, the AP receives, from the STA, one or more PPDU transmissions transmitted using a TXOP obtained with the EPCS enabled for the STA.

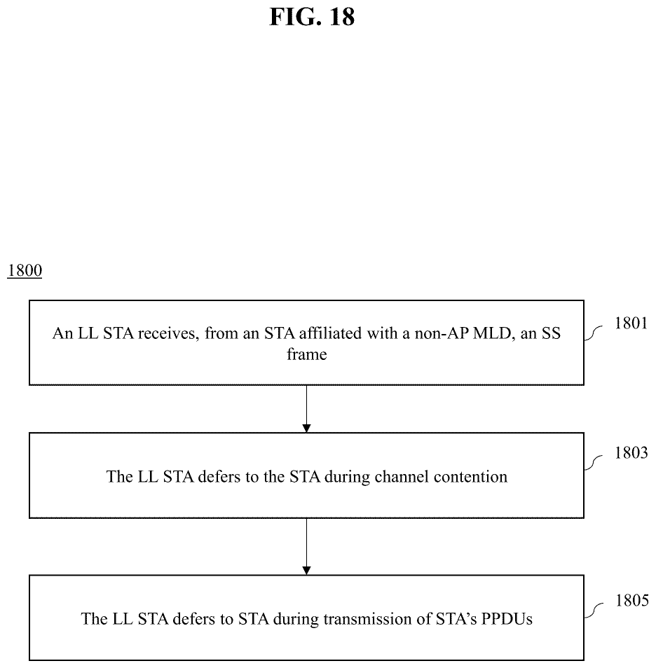

FIG. 18 shows an example process for an EPCS operation in accordance with an embodiment. The process depicted in FIG. 18 is for explanatory and illustration purposes. FIG. 18 does not limit the scope of this disclosure to any particular implementation.

Referring to FIG. 18, the processor 1800 begins at operation 1801. In operation 1801, an LL STA receives, from an STA affiliated with a non-AP MLD, an SS frame prior to an upcoming channel contention. The SS frame may be a DS frame. The LL STA may be participating in the channel contention and may receive the SS frame at AIFSN=1 or a number less than the LL STA's.

In operation 1803, the LL STA defers to the STA during channel contention. The LL STA may continue participation in channel contention but lose to the STA.

In operation 1805, the LL STA defers to the STA during the STA's transmission of one or more PPDUs. The LL STA may receive one or more PPDUs from the STA.

The disclosure provides mechanisms and protocols for handling EPCS operation so that an EPCS device has a higher probability of capturing a channel earlier than UHR devices during channel contention involving one or more UHR devices.

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A non-access point (AP) device for facilitating wireless communication, the non-AP device comprising:
one or more stations (STAs) affiliated with the non-AP device; and
a processor coupled to the one or more STAs, the processor configured to cause:
receiving, from an AP device, a frame including an enhanced distributed channel access (EDCA) parameter set that provides prioritized access to a wireless medium for emergency preparedness communication services (EPCS) traffic;
transmitting a defer signal that causes receiving devices to defer frame transmission;
accessing the wireless medium based on the EDCA parameter set; and
transmitting one or more frames including EPCS traffic over the wireless medium.

2. The non-AP device of claim 1, wherein the processor is further configured to cause:
transmitting, to the AP device, a request frame requesting the EDCA parameter set that provides prioritized access to the wireless medium for EPCS traffic.

3. The non-AP device of claim 1, wherein the EDCA parameter set includes one or more parameters that provide the EPCS traffic with a higher priority than non-EPCS traffic.

4. The non-AP device of claim 1, wherein the processor is further configured to cause:
receiving, from the AP device, a frame including an updated EDCA parameter set; and
accessing the wireless medium based on the updated EDCA parameter set.

5. The non-AP device of claim 1, wherein the EDCA parameter set is applied for one or more particular traffic types.

6. The non-AP device of claim 1, wherein the EDCA parameter set is applied for a particular STA affiliated with the non-AP device.

7. The non-AP device of claim 1, wherein the defer signal is transmitted at a predetermined time that is earlier than a defer signal transmitted by a device that does not transmit EPCS traffic.

8. The non-AP device of claim 1, wherein the defer signal is transmitted when a predetermined criteria is satisfied.

9. The non-AP device of claim 1, wherein the processor is further configured to cause:
transmitting a frame advertising a capability that supports transmitting EPCS traffic using a defer signal.

10. An access point (AP) device for facilitating wireless communication, the AP device comprising:
one or more APs affiliated with the AP device; and
a processor coupled to the one or more APs, the processor configured to cause:
receiving, from a non-AP device, a frame requesting priority access to a wireless medium for emergency preparedness communication services (EPCS) traffic; and
transmitting, to a non-AP device, a frame including an enhanced distributed channel access (EDCA) parameter set that provides prioritized access to the wireless medium for EPCS traffic.

11. The AP device of claim 10, wherein the EDCA parameter set includes one or more parameters that provide the EPCS traffic with a higher priority than non-EPCS traffic.

12. The AP device of claim 10, wherein the processor is further configured to cause:
transmitting, to the non-AP device, a frame including an updated EDCA parameter set.

13. The AP device of claim 10, wherein the EDCA parameter set is applied for one or more particular traffic types.

14. The AP device of claim 10, wherein the EDCA parameter set is applied for a particular station (STA) affiliated with the non-AP device.

15. The AP device of claim 10, wherein the processor is further configured to cause:
receiving, from the non-AP device, a frame advertising a capability that supports transmitting EPCS traffic using a defer signal.

16. The AP device of claim 10, wherein the processor is further configured to cause:
determining that a number of STAs associated with the AP device using any EDCA parameter sets providing the prioritized access for EPCS traffic is above a predetermined threshold; and
transmitting a frame indicating that the prioritized access is disabled.

17. A method performed by a non-access point (AP) device, the method comprising:
receiving, from an AP device, a frame including an enhanced distributed channel access (EDCA) parameter set that provides prioritized access to a wireless medium for emergency preparedness communication services (EPCS) traffic;
transmitting a defer signal that causes receiving devices to defer frame transmission;
accessing the wireless medium based on the EDCA parameter set; and
transmitting one or more frames including EPCS traffic over the wireless medium.

18. The method of claim 17, further comprising:
transmitting, to the AP device, a request frame requesting the EDCA parameter set that provides prioritized access to the wireless medium for EPCS traffic.

19. The method of claim 17, wherein the EDCA parameter set includes one or more parameters that provide the EPCS traffic with a higher priority than non-EPCS traffic.

20. The method of claim 17, further comprising:
receiving, from the AP device, a frame including an updated EDCA parameter set; and
accessing the wireless medium based on the updated EDCA parameter set.
